(19) United States
(12) Patent Application Publication
(10) Pub. No.: US 2021/0336508 A1
(43) Pub. Date: Oct. 28, 2021

(54) HIGH EFFICIENCY ACCEL/DECEL SERVO DEVICE AND SYSTEM

(71) Applicant: Gerald K. Langreck, Phillips, WI (US)

(72) Inventor: Gerald K. Langreck, Phillips, WI (US)

(21) Appl. No.: 17/111,908

(22) Filed: Dec. 4, 2020

Related U.S. Application Data
(63) Continuation of application No. 16/861,015, filed on Apr. 28, 2020, now abandoned.
Application No. 16/861,015 is a continuation of application No. 15/921,363, filed on Mar. 14, 2018, now abandoned.
Application No. 15/921,363 is a continuation of application No. 14/200,340, filed on Mar. 7, 2014, now abandoned.
(60) Provisional application No. 61/851,333, filed on Mar. 7, 2013.

(51) Int. Cl. H02K 7/10; H02K 7/14; B26D 5/08

(52) U.S. Cl. CPC H02K 7/10; H02K 7/02; B26D 5/086; H02K 7/14

(57) ABSTRACT

A servo system for driving a load having a servo motor, a servo drive operatively coupled to the servo motor and a cyclic force convertor operatively coupled to the load is disclosed.

### TECHNICAL FIELD OF THE INVENTION

The invention is in the general field of servo systems. More specifically the invention involves servo systems where a mass is being accelerated and decelerated in a continuously cyclic manner. An application of the invention is a dual rotary cut-off shear.

### BACKGROUND OF PRIOR ART

When a servo system accelerates and decelerates a mass in a continuous cyclic manner, the servo motor produces heat or thermal energy in the windings plus some iron losses which accumulates in the motor. Also the servo drive has to provide the current to the motor which causes heat or thermal energy to accumulate in the servo drive. As these servo systems are run at higher speeds to get more product out of their process, the rate of heat or thermal energy wasted in the servo motor and servo drive goes also higher. A cooling system must be provided to keep the servo motor and servo drive from exceeding its thermal limits or damage will occur. Blowing air over or through the servo motor and servo drive with fans and blowers is very common. To get even more product from their process, the servo system is speeded up where liquid cooling is necessary to keep the servo motor and servo drive from thermal damage. Depending on the product process, dirt and dust has to be filtered from these cooling systems which need to be changed regularly. Even with filters, some dust and dirt gets into the servo motor and servo drive which requires scheduled maintenance. Also the motors and drives reach temperatures that are a hazard to the touch so guards have to be put in placed to prevent personnel from getting burnt. Also liquid cooling systems are prone to leakage which requires extra maintenance.

Besides the cost of maintenance, a servo system that accelerates and decelerates a mass in a continuous cyclic manner wastes energy which adds to the cost of operation. This wasted energy also adds to the problem of global warming and this energy waste should be minimized or eliminated if possible.

### SUMMARY OF THE ADVANTAGES OF THE INVENTION

It is an objective of the invention to eliminate or at least greatly minimize the generation of heat or thermal energy in the type of servo system that accelerates and decelerates a mass in a continuous cyclic manner. To accomplish this, a highly energy efficient cyclic torque or force converter is added to the prior art servo system to relieve the inefficient servo motor of the cyclic inertial torque duty. With practically no thermal energy produced in the cyclic torque or force converter of the present invention, the cooling systems are eliminated along with all their maintenance cost. Also with practically no thermal energy produced in the servo motor, the servo motor can be designed with magnets of higher flux density giving more performance and higher speeds. Because the temperature of the present invention stays near ambient temperature, the magnetic field of the present invention will not decrease and/or demagnetize which happens to the prior art servo motors when the temperature rises. The servo motor windings and bearings of the present invention will have longer life which adds value to the system since the temperature will be near room temperature. Also the servo drive of the present invention will have longer life adding value to the system since it too will produce practically no thermal energy and the temperature will be near ambient temperature. In the prior art servo systems, cooling system extremes have to be used to get the most productivity of the product process as possible which otherwise leaves the servo system with less value. The thermal limits are the limiting factor of the speed of the prior art product process. With the present invention, since it will produce practically no thermal energy, the product process speed can be increased dramatically, adding value due to increased product output. Also because there's almost no waste energy with the present invention, there's savings in energy costs. The savings of the invention by producing no waste energy also saves costs involved in global warming.

### BRIEF DESCRIPTION OF THE DRAWINGS

The drawings, which constitute a part of the specification, are as follows:

FIG. 1 shows a prior art servo system;

FIG. 2(a) is a graph showing servo motor inertial torque, T and angular acceleration, ^{α};

FIG. 2(b) is a graph showing angular velocity, ^{ω};

FIG. 2(c) is a graph showing servo motor position, ^{θ};

FIG. 3 shows a servo system according to one embodiment of the invention;

FIG. 4(a) is a first graph showing servo motor torque;

FIG. 4(b) is a second graph showing servo motor torque;

FIG. 4(c) is a third graph showing servo motor torque;

FIG. 4(d) is a fourth graph showing servo motor torque;

FIG. 4(e) is a fifth graph showing servo motor torque;

FIG. 4(f) is a graph showing rotational mass angular acceleration, ^{α};

FIG. 4(g) is a graph showing rotational mass angular velocity, ^{ω};

FIG. 4(h) is a graph showing rotational mass angular position, ^{θ};

FIG. 5(a) shows a first servo device representing the cyclic torque converter of FIG. 3, with the rotatable permanent magnets shown in a first position, and a graph showing the torque, Tc;

FIG. 5(b) shows the servo device of FIG. 5 with the rotatable permanent magnets shown in a second position, and a graph showing the torque, Tc;

FIG. 5(c) shows the servo device of FIG. 5 with the rotatable permanent magnets shown in a third position, and a graph showing the torque, Tc;

FIG. 5(d) shows the servo device of FIG. 5 with the rotatable permanent magnets shown in a fourth position, and a graph showing the torque, Tc;

FIG. 5(e) shows the servo device of FIG. 5 with the rotatable permanent magnets shown in a fifth position, and a graph showing the torque, Tc;

FIG. 6(a) shows a second servo device representing the cyclic torque converter of FIG. 3;

FIG. 6(b) shows two of the servo devices of FIG. 6(a) connected by a shaft;

FIG. 7(a) is a graph showing the sum of the magnetic torques of the two servo devices of FIG. 6(b) with their stators in a first angular position relative to each other;

FIG. 7(b) is a graph showing the sum of the magnetic torques of the two servo devices of FIG. 6(b) with their stators in a second angular position relative to each other;

FIG. 7(c) is a graph showing the sum of the magnetic torques of the two servo devices of FIG. 6(b) with their stators in a third angular position relative to each other;

FIG. 7(d) is a graph showing the sum of the magnetic torques of the two servo devices of FIG. 6(b) with their stators in a fourth angular position relative to each other;

FIG. 7(e) is a graph showing the sum of the magnetic torques of the two servo devices of FIG. 6(b) with their stators in a fifth angular position relative to each other;

FIG. 8 shows a linear to rotary servo device representing the cyclic torque converter of FIG. 3;

FIG. 9(a) is a graph showing the angular torque Tc versus ^{θ} for the linear to rotary servo device of FIG. 8 when chamber A has a gas pressure of 1 and chamber B has a gas pressure of 0;

FIG. 9(b) is a graph showing the angular torque Tc versus ^{θ} for the linear to rotary servo device of FIG. 8 when chamber A has a gas pressure of ½0 and chamber B has a gas pressure of 0;

FIG. 9(c) is a graph showing the angular torque Tc versus ^{θ} for the linear to rotary servo device of FIG. 8 when chamber A has a gas pressure of 0 and chamber B has a gas pressure of 0;

FIG. 9(d) is a graph showing the angular torque Tc versus ^{θ} for the linear to rotary servo device of FIG. 8 when chamber A has a gas pressure of 0 and chamber B has a gas pressure of ½;

FIG. 9(e) is a graph showing the angular torque Tc versus ^{θ} for the linear to rotary servo device of FIG. 8 when chamber A has a gas pressure of 0 and chamber B has a gas pressure of 1;

FIG. 10 shows a second prior art servo system;

FIG. 11 shows a servo system according to another embodiment of the invention;

FIG. 12 shows a first dual rotary cut-off shear incorporating the servo system of FIG. 3;

FIG. 13(a) shows a second dual rotary cut-off shear incorporating the servo system of FIG. 3;

FIG. 13(b) shows a third dual rotary cut-off shear incorporating the servo system of FIG. 3;

FIG. 14(a) shows a fourth dual rotary cut-off shear incorporating the servo system of FIG. 3; and

FIG. 14(b) shows a fifth dual rotary cut-off shear incorporating the servo system of FIG. 3.

### DESCRIPTION OF THE INVENTION

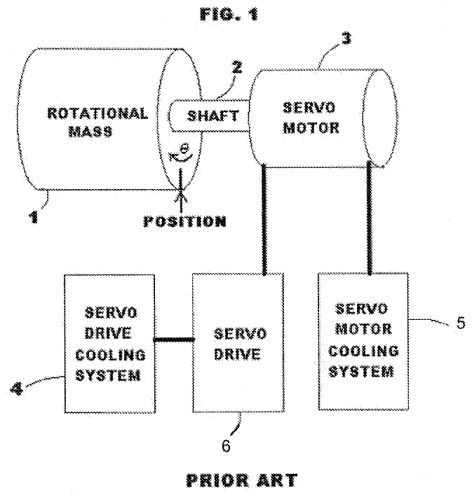

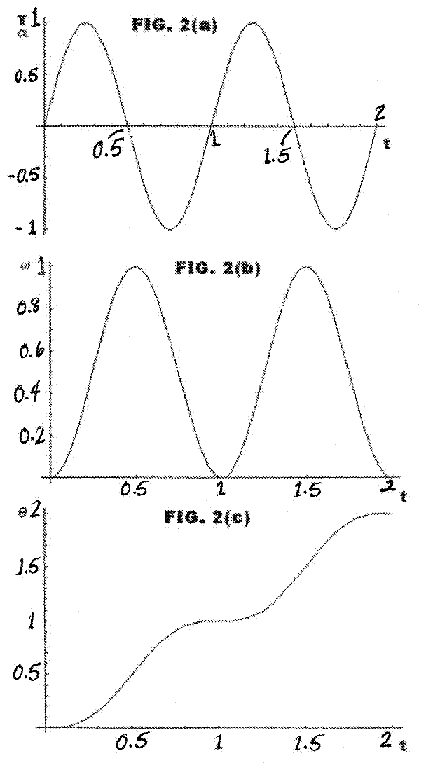

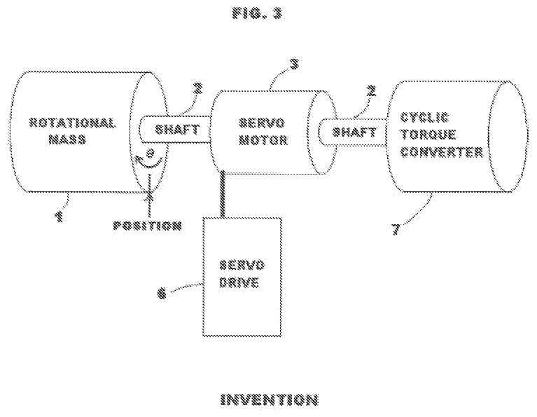

A prior art servo system is shown in FIG. 1. This system contains a rotational mass load 1, connected to the servo motor 3 by the shaft 2, a servo motor cooling system 5, a servo motor drive 6, and a servo drive cooling system 4. This servo system is programmed to produce the profiles to drive the acceleration of the rotational mass from 0 revolution to ½ revolution and decelerate the rotational mass from ½ revolution to 1 revolution and then repeat the process cyclically. The following graphs show 2 cycles (2 time units) of the cyclic process of inertial torque T, angular acceleration ^{α}, angular velocity ^{ω}, and angular position ^{θ} of the rotational mass. FIG. 2(a) is the graph of the servo motor inertial torque, T and angular acceleration, ^{α} for 2 cycles. FIG. 2(b) is the graph of the angular velocity, ^{ω} showing the angular velocity is 0 at the start, reaches peak velocity values at 0.5 and 1.5 time units, and finishes each cycle at 0 angular velocity. FIG. 2(c) is the graph of the servo motor position, ^{θ} starting at 0 revolutions and going to 1 revolution at 1 time unit, 2 revolutions at 2 time units, and the cyclic process continues for each cycle. The inertial torque, T is that part or component of the total torque, Ttotal that accelerates the rotational mass as opposed to the other torque parts or components such as friction, Tother. So the total torque Ttotal=T+Tother.

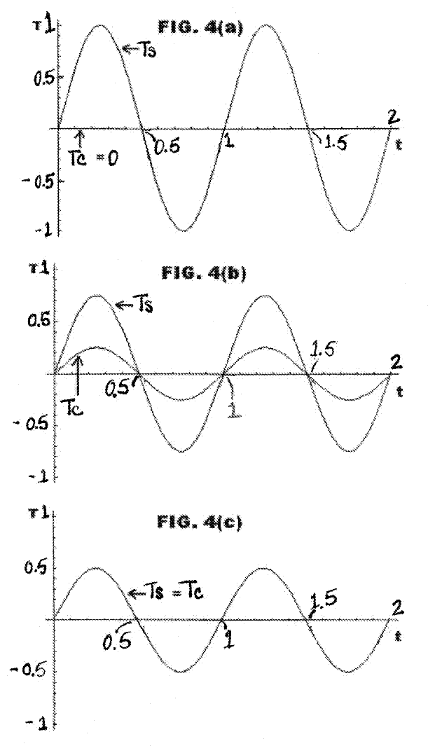

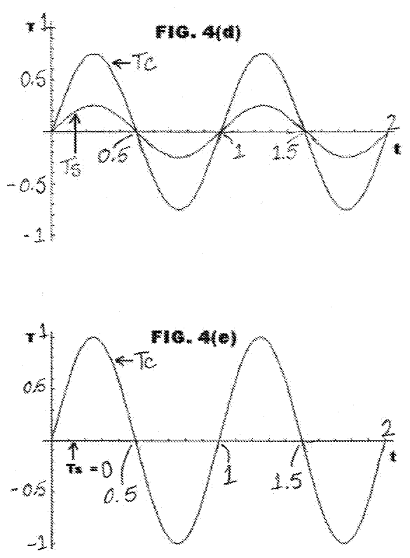

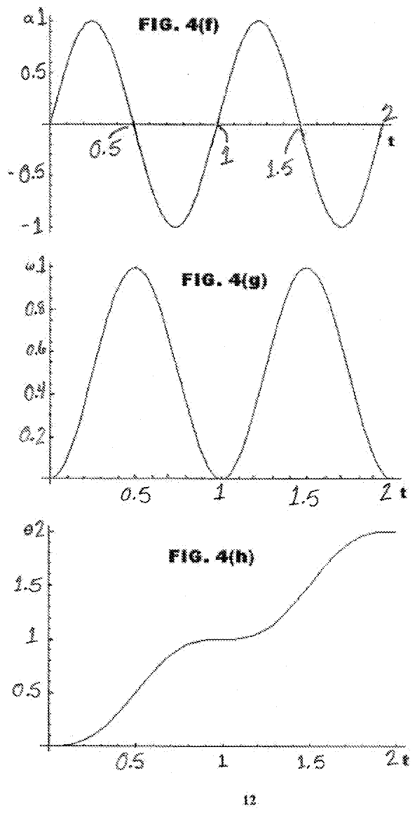

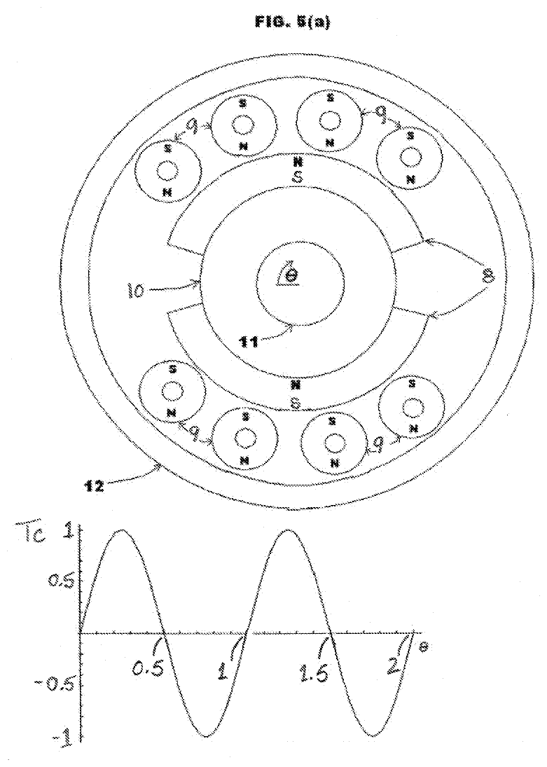

FIG. 3 is the servo system invention. The invention adds a very energy efficient device, the cyclic torque converter 7, to the prior art servo system and deletes the unnecessary servo motor cooling system and the servo drive cooling system. FIG. 4(a) shows the servo motor torque, Ts=T, providing all the inertial torque, T as in FIG. 2(a), and the cyclic torque converter providing no torque, Tc=0. FIG. 4(b) shows Ts=¾ T of the inertial torque as the cyclic torque converter is turned up to Tc=¼ T of the inertial torque. FIG. 4(c) shows Ts=½ T as the cyclic torque converter is turned up to Tc=½ T. FIG. 4(d) shows Ts=¼ T as the cyclic torque converter is turned up to Tc=¾ T. FIG. 4(e) shows Ts=0 as the cyclic torque converter is turned up to Tc=T. FIG. 4(f) is a graph of the rotational mass angular acceleration ^{α}, for 2 time units. FIG. 4(g) is a graph of the rotational mass angular velocity, ^{ω}. FIG. 4(h) is a graph of the rotational mass angular position, ^{θ}. Note the servo system always provides the total servo torque, Ttotal=T+Tother, necessary to keep the rotational mass following the prescribed profiles, angular acceleration ^{α}, angular velocity ^{ω}, and angular position ^{θ} of the rotational mass. The inertial torque T=Ts+Tc is always equals to magnitude) at any one prescribed profile. The value of Ts is brought down by increasing the value of Tc until Ts is near zero. This gives the optimum energy efficiency of the servo system. With the torque of the servo motor near zero, the I²R losses are almost zero. And since the torque of the servo motor is zero, the current of the servo drive is near zero which then produces almost zero heat losses in the servo drive. It should be noted here that the profile for the angular acceleration, angular velocity, and angular position of the above example is only one of an infinite number of profiles and the present invention with proper design and variability can accommodate most applications.

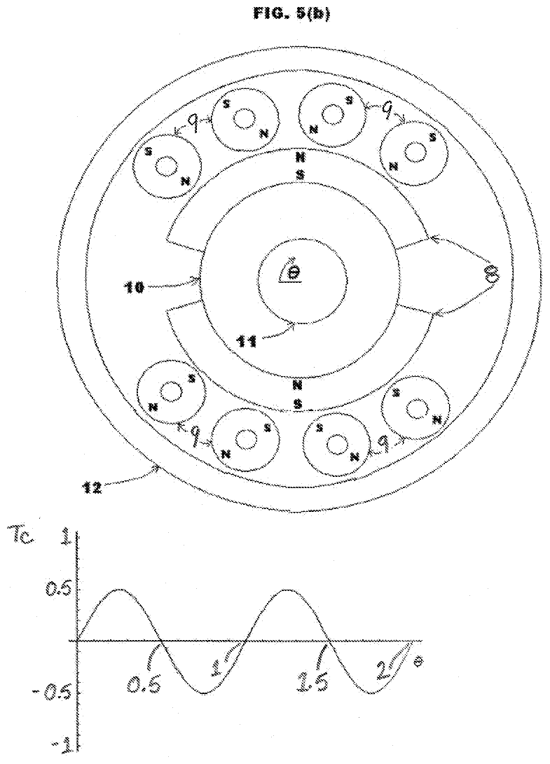

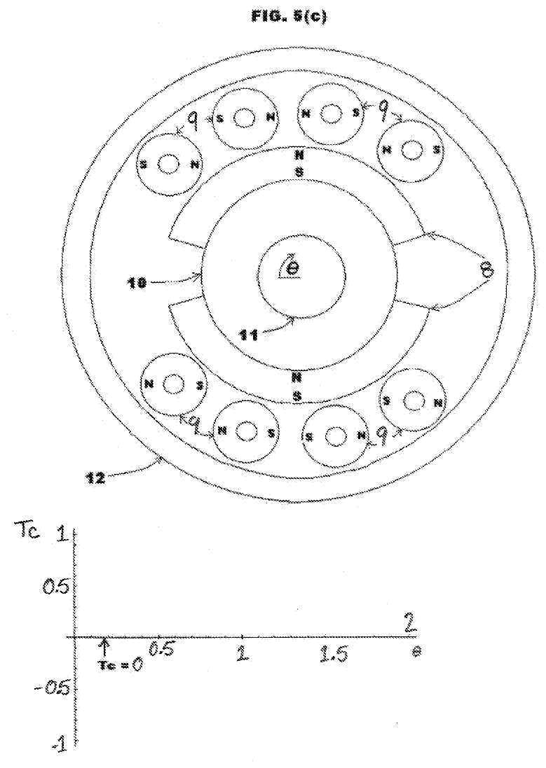

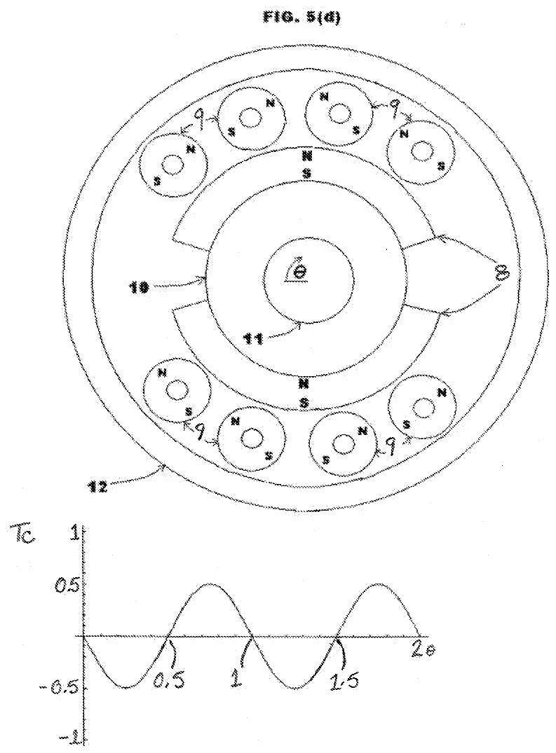

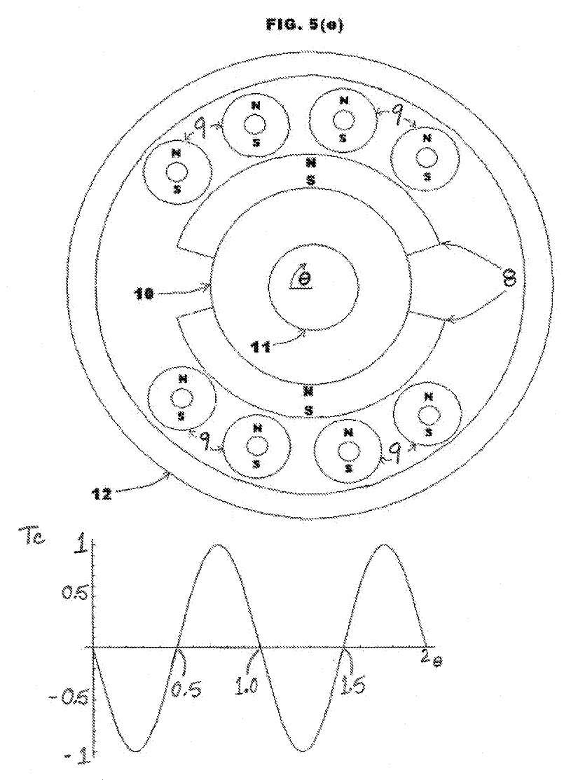

FIG. 5(a) is a servo device invention representing the cyclic torque converter 7 in FIG. 3. The magnetic torque converter consists of a rotor of magnetizable material 10, with permanent magnets 8, attached to the rotor. The stator 12, is magnetizable material with rotatable permanent magnets 9, mounted to the stator. The magnetic interaction of the rotatable permanent magnets 9, and the rotor permanent magnets 8, give torque to shaft 11, in the direction indicated by ^{θ}. With the rotor 9, in the position shown in FIG. 5(a), the torque Tc versus ^{θ} is shown in the graph below. In FIG. 5(b) the rotatable permanent magnets 9 are rotated to the position shown will decrease the torque function from Tc=1 to Tc=½. In FIG. 5(c) the rotatable permanent magnets 9 are rotated to the position shown will decrease the torque function from Tc=½ to Tc=0. In FIG. 5(d) the rotatable permanent magnets 9 are rotated to the position shown will decrease the torque function from Tc=0 to Tc=−½. In FIG. 5(e) the rotatable permanent magnets 9 are rotated to the position shown will decrease the torque function from Tc=−½ to Tc=−1.

The design of the magnetic cyclic torque converter has considerable options. The torque produced by the permanent magnet interaction of the magnetic cyclic torque converter produces no heat while held stationary. And when the rotor is moving, only small eddy current and magnetic material losses produce very little heat energy. The eddy current and magnetic material losses are so low that the magnetic cyclic torque converter will only rise a few degrees above ambient. Also with state of the art high flux density permanent magnets that operate at low temperatures, a very high flux density can be achieved resulting in a continuous torque value that exceeds the continuous torque value of the servo motor for the same size device. The servo motor has resistive I²R losses which the magnetic cyclic torque converter does not have. Again, since the cyclic torque converter takes all the cyclic inertial torque, the lossy servo motor torque is near zero with almost no I²R losses. This is the heart of the invention. The cyclic torque converter takes over the inertial torque which leaves the lossy servo motor not having to provide this torque and thus stays cool.

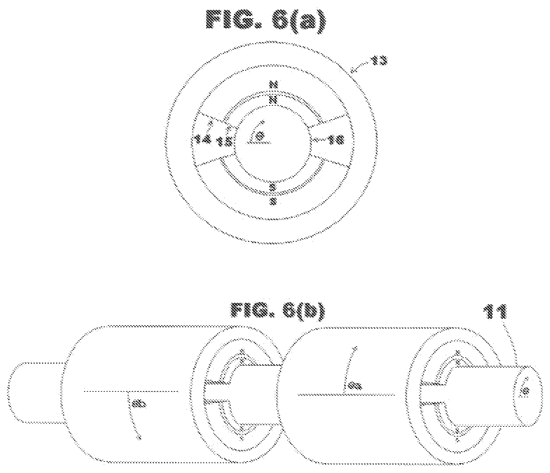

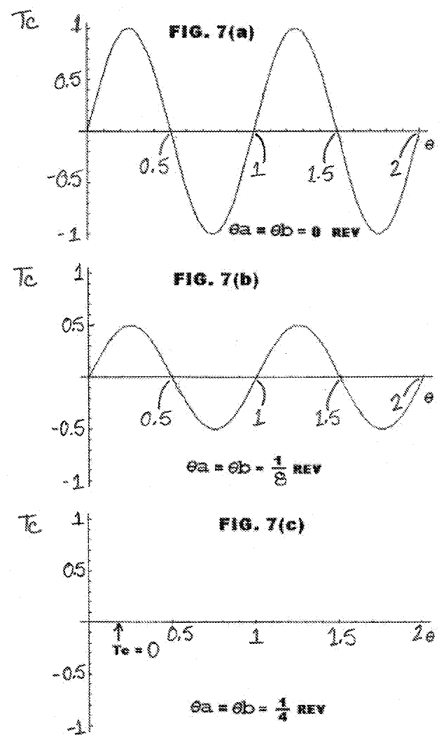

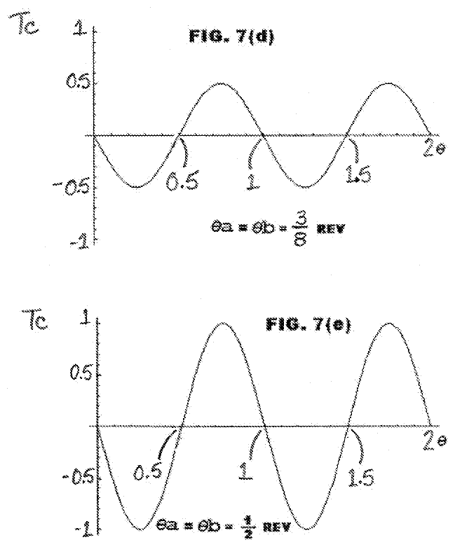

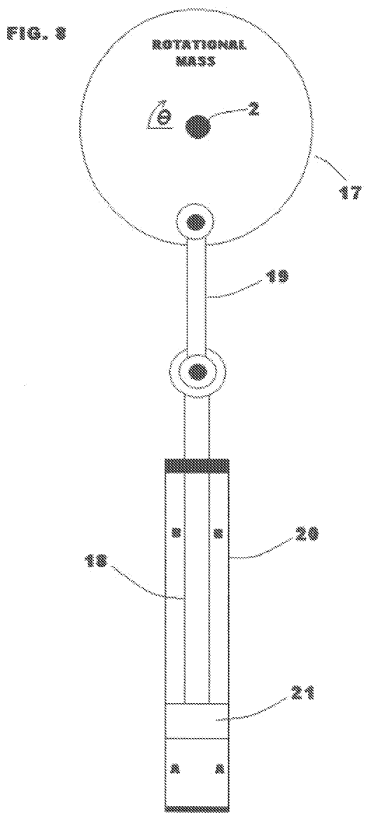

FIG. 6(a) is another magnetic servo device invention representing the cyclic torque converter 7 in FIG. 3. This magnetic cyclic torque converter consists of a rotor of magnetizable material 16, with permanent magnets 15 attached to the rotor 16. The stator of magnetizable material 13 has permanent magnets 14 attached to it. FIG. 6(b) shows two of the devices of FIG. 6(a) connected by shaft 11. Each stator has an angular position indicator shown. One stator has angular position indicated by ^{θa} and the other stator angular position indicated by ^{θb}. With ^{θa=θb=0} the sum of the magnetic torques Tc versus ^{θ} of the two devices will be as shown in FIG. 7(a). With each stator moved where ^{θa=θb=1/8 REV} the sum of the magnetic torques Tc versus ^{θ} of the two devices will be as shown in FIG. 7(b). With each stator moved where ^{θa=θb=1/4 REV} the sum of the magnetic torques Tc versus ^{θ} of the two devices will be as shown in FIG. 7(c). With each stator moved where ^{θa=θb=3/8 REV} the sum of the magnetic torques Tc versus ^{θ} of the two devices will be as shown in FIG. 7(d). With each stator moved where ^{θa=θb=1/2 REV} the sum of the magnetic torques Tc versus ^{θ} of the two devices will be as shown in FIG. 7(e).

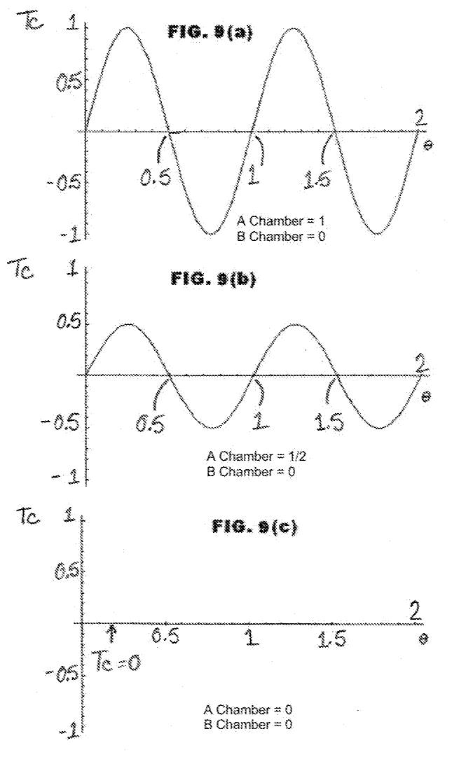

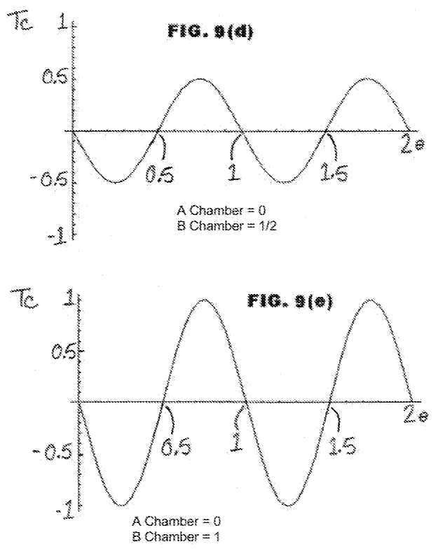

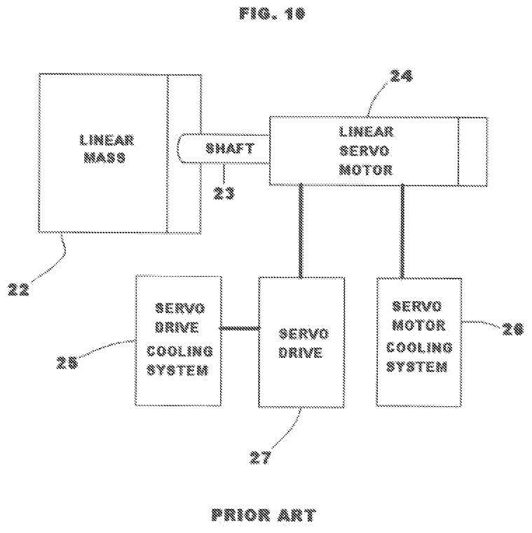

FIG. 8 is a linear to rotary servo device invention representing the cyclic torque converter 7 in FIG. 3. The linear rotary torque converter consists of a gas linear force cylinder 20 with piston 21 producing linear force through link 18 depending on gas pressures in chamber A and chamber B. The linear force connected to the rotary mass 17 through link 19 produces rotary torque to shaft 2 in the direction indicted by ^{θ}. FIG. 9(a) shows the angular torque Tc versus ^{θ} when chamber A has a gas pressure of 1 and chamber B has a gas pressure of 0. FIG. 9(b) shows the angular torque Tc versus ^{θ} when chamber A has a gas pressure of ½ and chamber B has a gas pressure of 0. FIG. 9(c) shows the angular torque Tc versus ^{θ} when chamber A has a gas pressure of 0 and chamber B has a gas pressure of 0. FIG. 9(d) shows the angular torque Tc versus ^{θ} when chamber A has a gas pressure of 0 and chamber B has a gas pressure of ½. FIG. 9(e) shows the angular torque Tc versus ^{θ} when chamber A has a gas pressure of 0 and chamber B has a gas pressure of 1. Note by varying the pressures of the chambers, almost any Tc versus ^{θ} function can be achieved.

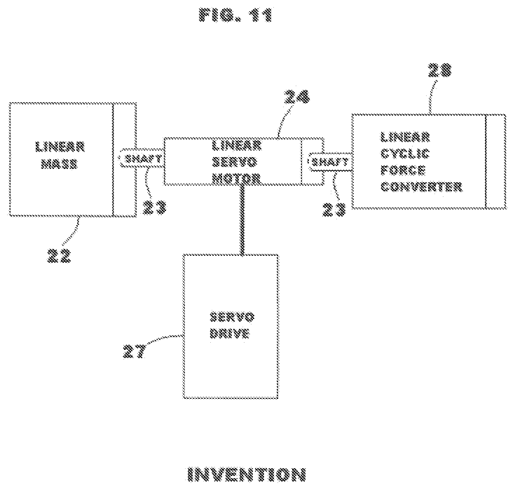

Another prior art servo system is shown in FIG. 10. This system consists of a linear mass load 22 connected to the linear servo motor 24 by shaft 23. The linear servo motor 24 has servo motor cooling system 26. The linear servo motor 24 is driven by servo drive 27 and is cooled by servo drive cooling system 25. Its assumed this servo system is also programmed to follow cyclic profiles like the rotary versions.

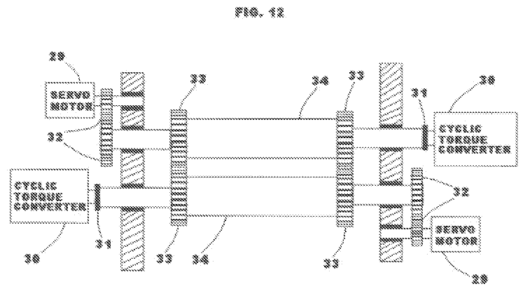

FIG. 11 is a linear version of the invention. A highly efficient linear cyclic force converter 28 device is added to the prior art linear servo system of FIG. 10. Also the unnecessary servo motor cooling system 26 and servo drive cooling system 25 are deleted. Again the highly energy efficient linear force converter takes over the inertial force part of the total force resulting in a highly energy efficient linear servo system for cyclic profiles.

### Application of the Invention to Dual Rotary Cut-Off Shears

Dual rotary cut-off shears are good applications of the present invention because while cutting their product into sheet lengths, they must accelerate and decelerate the massive counter rotating shear drums in a continuous cyclic manner. For these shears, there's only one sheet length that doesn't require an acceleration or deceleration of the shear drums. This sheet length is termed synchronous sheet length and is exactly the cut circumference of the shear drum. To cut a longer than synchronous sheet length, the shear drums must be decelerated after the product is cut for ½ revolution and then accelerated for the next ½ revolution to match the product velocity to make the next cut and then repeat the process. To cut a shorter than synchronous sheet length, the shear drums must be accelerated after the product is cut for ½ revolution and then decelerated for the next ½ revolution to match the product velocity to make the next cut and then repeat the process. There's competition in getting more product out per time to get the cost of the product as low as possible so it's desirable to run faster if possible. For the dual rotary cut-off shears, it's especially difficult for the servo motors and servo drives as the sheet length goes toward shorter lengths. The servo motors and servo drives are driven to their thermal limit at some product velocity and to be able to cut shorter sheet lengths the product velocity must be decreased or the servo motors and servo drives will be damaged. The present invention will allow running short sheet lengths much faster than prior art servo systems resulting in more product per time. Also for longer than synchronous sheet lengths the prior art servo systems will reach their thermal limits at some product velocity and the present invention will allow higher product velocity resulting again in more product per time. Also because there's competition in getting more product out per time to get the cost of the product as low as possible, the dual cutoff shears incorporate cooling systems that requires maintenance. Also this heat energy that cools the servo motors and servo drives is wasted and adds energy costs along with the costs of global warming.

FIG. 12 is a drawing of a dual rotary cut-off shear incorporating the invention of FIG. 3. Refer to FIG. 2 of U.S. Pat. No 4,630,514. A servo device invention, the cyclic torque converter 30 is directly coupled to the drum shaft through coupling 31. The rotational mass load drums 34 are kept at equal counter rotating angular velocity by gears 33. A gear set 32 allows the servo motor 29 to provide torque to the inertial load drums 34. This dual rotary shear constitutes a cyclic profiled servo system of the invention of FIG. 3. Note FIG. 12 shows two cyclic torque converters 30 and two servo motors 29. To apply the invention, any combination of cyclic torque converters 30 and servo motors 29 in mechanical parallel connection can be used.

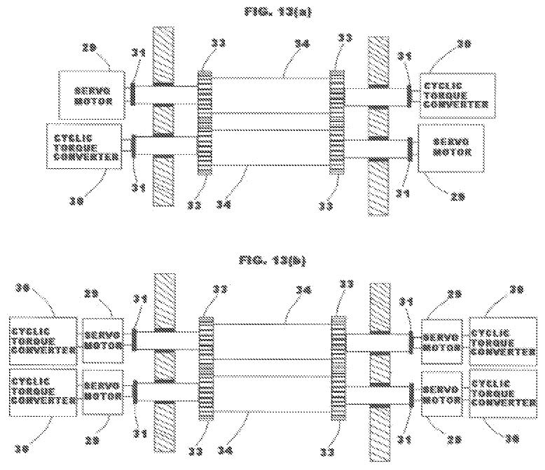

FIG. 13(a) and FIG. 13(b) are drawings of dual rotary cut-off shears incorporating the invention of FIG. 3. FIG. 13(a) differs from FIG. 12 only by the servo motors 29 driving the load drums 34 directly, eliminating the gear set 32 of FIG. 12 and adding a coupling 31 between the servo motors 29 and the drive shaft of the load drums 34. A further advantage can be obtained by driving all load drum shafts equally. Refer to U.S. Pat. No. 6,142,048 for all advantages of this design. According to U.S. Pat. No. 6,142,048 the gear sets 33 can be reduced in strength if all load drums 34 are driven equally as they would be if configured like FIG. 13(b). Also there's minimization of the size of the servo motors 29 and cyclic torque converters 30. Also, according to U.S. Pat. No. 6,065,382, use of composite fiber material for the load drums 34 will minimize the size of the servo motors 29 and cyclic torque converters 30.

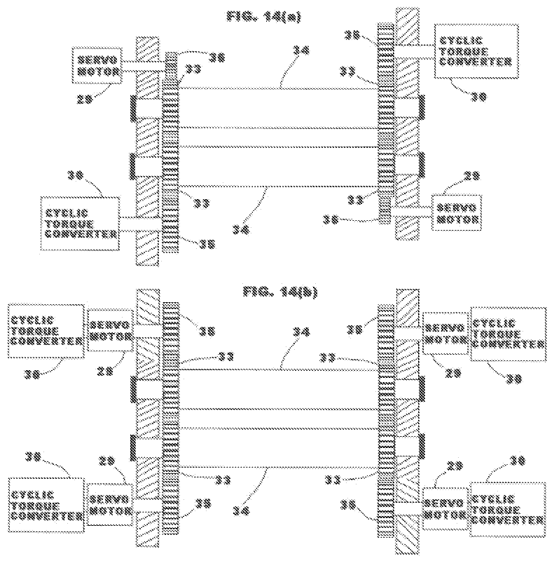

FIG. 14(a) and FIG. 14(b) are drawings of dual rotary cut-off shears incorporating the invention of FIG. 3. These cut-off shears differ from the others in that the load drums 34 are hollow and the shafts that go through the hollow load drums are fixed at the frames. Refer to U.S. Pat Nos. 6,389,941 and 4,756,219 as the cut-off shears in these patents incorporate hollow load drums. So in FIG. 14(a) the hollow load drums 34 must be driven by the gears 33. The servo motors 29 drive the load drums 34 through gears 36 and 33. The cyclic torque converters 30 drive the load drums 34 through gears 35 and 33. Note the large gears 35 must have the same tooth number as gears 33. The cut-off shear of FIG. 14(b) has large gears 35 driving gears 33 to drive the load drums 34. Having the servo motors 29 and cyclic torque converters 30 driving the large gears 35 will distribute the total torque better to the gears 33.

The embodiments of the invention in which an exclusive property or privilege is claimed are defined as follows:

1. A servo system for driving a load, the servo system comprising:
a servo motor operatively coupled to the load;
a servo drive operatively coupled to the servo motor; and
a cyclic force convertor operatively coupled to the load.
